(19) United States
(12) Patent Application Publication
(10) Pub. No.: US 2026/0127275 A1
(43) Pub. Date: May 7, 2026

(54) DIGITAL IN-MEMORY COMPUTATION WITH SECURITY AGAINST PHYSICAL SIDE-CHANNEL AND MEMORY BUS PROBING ATTACKS

(71) Applicants: INTERNATIONAL BUSINESS MACHINES CORPORATION, ARMONK, NY (US); MASSACHUSETTS INSTITUTE OF TECHNOLOGY, CAMBRIDGE, MA (US)

(72) Inventors: Maitreyi Ashok, Cambridge, MA (US); Saurav Maji, Hillsboro, OR (US); Xin Zhang, Chappaqua, NY (US); Anantha Chandrakasan, Belmont, MA (US)

(21) Appl. No.: 18/936,900

(22) Filed: Nov. 4, 2024

(51) Int. Cl. G06F 21/55; H04L 9/08

(52) U.S. Cl. CPC G06F 21/554; H04L 9/0861; G06F 2221/034

(57) ABSTRACT

An accelerator device architecture for a computing chip includes a secure Boolean shared in-memory circuit for side-channel attack security. A cipher circuit is coupled to the in-memory circuit for bus probing attack security. A physical-unclonable function cell is coupled to the in-memory circuit. The physical-unclonable function cell is configured to generate a security key using memory in the in-memory circuit.

### BACKGROUND

### Technical Field

The present disclosure generally relates to computing hardware, and more particularly to digital in-memory computation with security against physical side-channel and memory bus probing attacks.

### Description of the Related Art

In-memory computing is a computer architecture in which data operations are performed directly in the data memory, rather than having to be transferred to CPU registers first. This may improve the power usage and performance of moving data between the processor and the main memory. Within in-memory computing, analog and digital architectures have been proposed.

In SRAM-based analog in-memory compute (AIMC) architectures, the compute array and the external memory levels maximize the array utilization by using a weight stationary dataflow. This dataflow aims at minimizing the data movement related to weights, maximizing their reuse at the computational array level. Bit weights are pre-loaded into the array, where memory cells are grouped and attached on the local bitline to increase memory density. To execute a matrix vector multiplication (MVM), a digital input vector is provided along the wordlines of the memory array. The values of each element of the vector are converted to the analog domain with DACs. The resulting signals are propagated along all wordlines in parallel. The analog signal on the wordlines is then combined with the value stored in the activated SRAM cells performing one multiplication per cell. The result of each multiplication will be transmitted onto the bitlines, where accumulation occurs in the analog domain across all cells connected to the same bitline. The final value on the bitlines is then converted back to the digital domain through ADCs, stored in output registers, after which the converted value flows back to the higher-level memories.

Digital in-memory computing (DIMC) schemes rely on manually decomposing arithmetic operations into in-memory compute kernels. In contrast, traditional digital circuits are synthesized using complex and automated design flows. The multiplication and accumulation operation in a DIMC are conventionally implemented with digital logic gate-based multiplier and adder circuitry using for example, AND type gates. IMC multiplication is done at the SRAM cell level, where memory cells feed data to nearby NAND gates. The digital MAC results can immediately be offloaded to output registers after accumulating the full precision results in digital accumulators. The presence of extra logic at cell level and the adder trees in DIMC give rise to area overheads and lower peak energy efficiencies compared to an AIMC architecture.

### SUMMARY

According to an embodiment of the present disclosure, an accelerator device architecture for a computing chip is disclosed. The architecture includes a Boolean shared in-memory circuit for side-channel security. A cipher circuit is coupled to the in-memory circuit for bus probing attack security. A physical-unclonable function cell is coupled to the in-memory circuit. The physical-unclonable function cell is configured to generate a security key using memory in the in-memory circuit.

According to an embodiment of the present disclosure, a computing chip is disclosed. The computing chip includes an input for receipt of encrypted neural network data and a digital in-memory compute accelerator. The digital in-memory compute accelerator includes a Boolean shared in-memory circuit. A cipher circuit is coupled to the in-memory circuit for bus probing attack security and coupled to the input for receipt of encrypted neural network model data. A physical-unclonable function cell is coupled to the in-memory circuit. The physical-unclonable function cell is configured to generate a security key used to decipher the encrypted neural network model data using memory in the in-memory circuit.

According to an embodiment of the present disclosure, a method of operating an accelerator on a computing chip to process neural network model data is disclosed. The method includes generating a physically unclonable function (PUF) cell in an in-memory compute circuit of the accelerator. A secret key is generated using the physically unclonable function cell using an in-memory compute memory bank in the accelerator. A part of a neural network model is retrieved from off the computing chip. The retrieved part of the neural network model is decrypted locally on the computing chip using the secret key generated from the physically unclonable function cell. The decrypted retrieved part of the neural network model is written to the in-memory compute memory bank. An in-memory compute operation is performed on the decrypted retrieved part of the neural network model. Neural network output data is obtained on the computing chip from the performance of the in-memory compute operation.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a digital in-memory computing device architecture with built-in security against side channel attacks, consistent with an illustrative embodiment.

FIG. 2 is a schematic view of a Boolean shared multiply scheme for side-channel security in a digital in-memory computing device architecture, consistent with an illustrative embodiment.

FIG. 3 is a schematic view of a bit cell for a digital in-memory computing device architecture, consistent with an illustrative embodiment.

FIG. 4 is a flowchart of a method of generating a security measure in a digital in-memory computing device, according to an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Digital In-Memory Computing (DIMC), as used herein, refers to a computing paradigm in which memory devices, used in a digital manner, are used to encode data and to perform part or the whole computation associated with a workload (for example, a neural network).

Side-Channel Attack, as used herein, refers to the interception of information or data in a computing system using an in-memory computing device, via measuring physical leakage sources of the IMC device.

Bus probing attacks, as used herein, refer to probing off-chip memory for information.

Neural network, as used herein, refers to a computational learning system that uses a network of functions to understand and translate a data input of one form into a desired output.

Boolean, as used herein, refers to logic structures that result in one of two values.

Physical-unclonable function, as used herein, refers to a section of a computing chip that is used to generate a unique, unpredictable, and robust value based on the inherent device variations in the chip.

Clock cycle, as used herein, refers to a cycle in which multiply output partial products are computed. In the embodiments below, the entire computation may be pipelined so that 1 multiply-accumulate operation is performed for every clock per column.

### Overview

The present disclosure generally relates to DIMC systems. DIMC machine learning accelerators of the subject technology interleave computation logic with memory cells to balance between reduced data transfer energy and high computation accuracy. For example, there may be some memory bit cells in a column next to an adder tree column that receives the multiplier output and then a next column of memory bit cells, and so on. The balance provides real-time inference decisions while reducing privacy risks when sending raw server data to a remote server. However, existing DIMC structures and methods for digital in-memory compute are not secure against physical side channel attacks or attacks that probe the off-chip memory bus. Would-be exploiters can gain access to data from DIMCs by accessing measuring leakage sources of the IMC device or off-chip memory and gleaning information therefrom. In machine learning applications, side-channel attacks (SCAs) provide third parties with valuable insights into the machine learning algorithms. In addition, machine learning processes can be corrupted by generating adversarial inputs through knowledge of the DIMC calculations via the side-channels.

Machine learning (ML) accelerators provide energy efficient neural network (NN) implementations for applications such as speech recognition and image processing. A digital IMC reduces data transfer energy, while still allowing for higher bitwidths and accuracies necessary for many workloads, especially with technology scaling. As noted above, privacy of ML workloads can be exploited with physical side-channel attacks or bus probing attacks (BPAs). While SCAs correlate integrated circuit power consumption or electromagnetic emissions to data or operations, BPAs directly tap traces between the integrated circuit and off-chip memory. The inputs reflect private data collected on Internet of Things devices, such as images of faces. The weights (values), typically stored off-chip, reveal information about proprietary private training datasets. The subject technology provides among other features, an IMC macro protected against SCAs and BPAs to mitigate these risks.

SCA security through the naive application of existing techniques comes with prohibitive overheads for IMC. Threshold implementations (TI) are a common method for guaranteed SCA resilience, where each data bit is split into separately computed shares. A “share” in this context, is part of the representation of a binary value. For example, if one wants to split each value into 2 shares, the shares can be represented as 0 XOR 0 or 1 XOR 1. Similarly, the shares can be represented as 0 XOR 1 or 1 XOR 0. Maintaining the security of TI computations requires uniform shares, and random bits are generally used to ‘refresh’ non-uniform ones by remasking. With the high parallelism of IMC accelerators, just the multiply operation would need >8 k random bits in each clock for the macro size considered, which would require >700 copies of the PRNG-mode ASCON cipher. However, natively secure functions produce uniform outputs by default, and do not require random bit refreshing. Furthermore, for BPA security, the model and encryption secret keys should never be present in plaintext off-chip. At the same time, there is no practical need for security beyond a certain number of measurements, due to limited attacker signal to noise ratio (SNR) and the difficulty of stealthy physical attacks for long durations.

Some previous approaches tried to protect deep learning models by doing some sort of private transformation after the inputs before doing any of the public training and inference so that the model is split into private computations and the public computations. The main reason this is done is so that anyone can be provided with access to a machine learning model, but they cannot use the model without knowing this transformation. And so, this is not actually for cryptographically secure systems since this transformation is often a discrete Fourier transform or the 1st layer of the deep neural network. Thus, the transform approach remains vulnerable because the rest of the model is still working with real data that can be accessed through side channel attacks.

Another approach uses a trusted execution environment with cryptographic cache lines. The approach is done by having a processor core and its coupled memory controller read a cache line, verify that the cache line is authentic using a message authentication code, and then decrypt the line. The approach makes sure that it is confidential and has high integrity so that one does not have to replay attacks on the cache lines or anything similar. While this means that the transmission of data is secure, the computation that is done after this data is received from the cache does not have any sort of side channel protection on it.

As will be appreciated, the subject technology disclosed below combines features on-chip that prevent SCA and BPAs from accessing potentially informative data from machine learning processes. Security measures are maintained on-chip including generating ciphers and power-decorrelated computation on-chip, so that any decryption of and operation with machine learning data remains on the chip and beyond the reach of SCAs and BPAs. Moreover, the efficiency of computing resources used in the accelerator operation are improved over conventional approaches because secret key generation uses memory that exists on-chip normally used exclusively for in-memory compute operations, instead of having a separate dedicated memory bank.

### Example Architecture

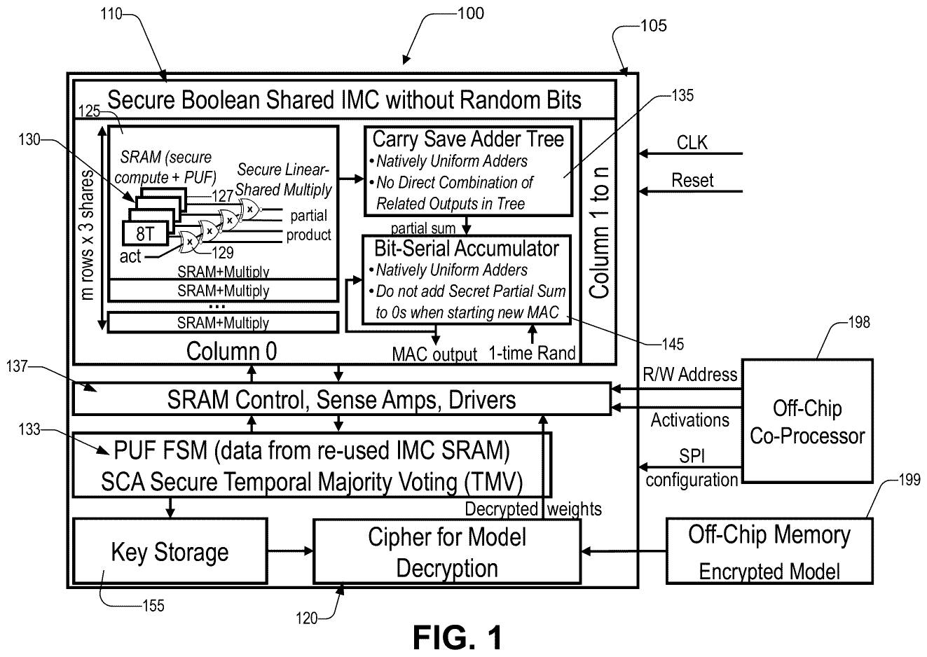

According to an embodiment of the present disclosure, a digital IMC accelerator 100 is disclosed. FIG. 1 shows an architecture of the digital IMC accelerator 100 with practical levels of security against two types of attacks; physical side channel attacks and memory bus probing attacks. The digital IMC accelerator 100 may be an integrated circuit on a section of a computing chip 105. The computing chip 105 may be connected to other chip devices on the same chip 105 as well as off-chip components (for example, off-chip co-processor 198 and/or off-chip memory encrypted model 199). Examples of input signals to the digital IMC accelerator 100 can be seen associated with the off-chip components as well as clock and reset signals. It will be understood that the output from the digital IMC accelerator 100 is sent to one or more other on-chip components (not shown) and/or off-chip components depending on the application of use. While shown in block form, it will be understood that the elements in the architecture represent circuit features that are either stand-alone elements or sub-circuits of the digital IMC accelerator 100.

The digital IMC accelerator 100 includes a SCA-secure multiply and accumulate in-memory compute circuit 110 (sometimes referred to as “IMC circuit 110”). The in-memory compute circuit 110 has reduced latency and does not require fresh random bits for security. The digital IMC accelerator 100 also includes an on-chip cipher circuit 120 that is configured to protect against bus probing attacks. In some embodiments, the on-chip cipher circuit is a NIST-standard lightweight ASCON circuit. The digital IMC accelerator 100 also includes a feedback-cut physical-unclonable function (PUF) cell 130 that uses the memory present in the IMC circuit 110 for key generation. A finite state machine 133 reads out the values from the PUF cell 130 and stabilizes the values. Some embodiments include peripheral units 137 for controlling actions between other elements such as read/write events to the SRAM block, amp sensing, and drivers.

The IMC circuit 110 may include a side channel secure multiply logic module 125, one or more adder trees 135, and bit serial accumulator 145. The IMC circuit 110 may perform secure computations using a Boolean sharing type protection where if each data and function is split into independent shares, the computation of each of these shares is uncorrelated from the overall actual value, which means the total power consumption is also. The sharing is referred to as “Boolean” since the shares combine to form the original value through a Boolean operation (s1 XOR s2 XOR s3=data) rather than an arithmetic one (s1+s2+s3=data). The architecture is also protected from off-chip transmissions (i.e., bus-probing attacks and any form of cold boot attack on the off-chip memory), by transferring signals in an encrypted domain off chip (for example using an encrypted model in the off-chip memory 199), and locally decrypting the model (for example, using a cipher to decrypt neural network data in the cipher circuit 120), as necessary right before the actual computation is performed. Some embodiments of the IMC circuit 110 may include a secret key 155 to provide cryptographic guarantees to this cipher. When the secret key is sent from off chip, the key is subject to being probed. As such, there is a vulnerability that needs to be addressed.

The subject technology addresses the vulnerability described above by generating the key on chip, for example, by using the existing in-memory compute circuit memory, which may be SRAM bit cells 127 present in the side channel secure multiply logic module 125. The SRAM bit cells 127 may generate a key based on fabrication variations in the chip structure that will vary from chip to chip (PUF cell 130). The PUF cell 130 signature may be based on a section of the chip inside the area of the accelerator. In the embodiment shown in FIG. 1, the PUF cell 130 is shown reusing the IMC SRAM which reduces the area cost associated with fabrication. In some embodiments, the PUF cell 130 may be based on a section that is on-chip but outside the accelerator. As may be appreciated, the key fabrication is not able to be controlled by anyone since the key's generation is based on the physical chip structure. Thus, the key value may not be cloned or otherwise deciphered externally without knowing the physical structure of the chip.

In some embodiments, the key is initially generated based on what was used in the enrollment phase for the chip and what was used for the model, and the data model is sent from non-volatile memory or DRAM after encryption with this key. The same key may be regenerated post-deployment and used to decrypt locally on the chip, and the computation is performed on the inputs and the model weights in this Boolean shared format of the side channel secure multiply logic module 125 to do the secure multiply and accumulate of the weights and activations. Accordingly, very high security levels are achieved with low latency without requiring fresh random bits for each computation.

### Example In-Memory Computation

To perform the computation with a secure multiply, a secure add and a secure bit serial accumulation, the outputs from a neural network layer is obtained and then the layer's output is sent into the next layer in a successive format. This can be seen in the representation shown in the block representing the side channel secure multiply logic module 125. For side channel security the secure computation can be performed without requiring random bits by using gates that are already natively secure. For example, traditionally, when using an AND gate, one bit may be multiplied by another bit. This can be very hard to implement in a secure way by doing this Boolean sharing protection because AND gates are nonlinear, which means that some extra components need to be added to the function to be able to still get a correct result that does not use all of the shares in any of the components.

In the embodiment of FIG. 1, the side channel secure multiply logic module 125 may include an XNOR gate 129. The XNOR gate 129 may be used as a multiplier of the weight stored by bit cells 127 and an input activation (“act”).

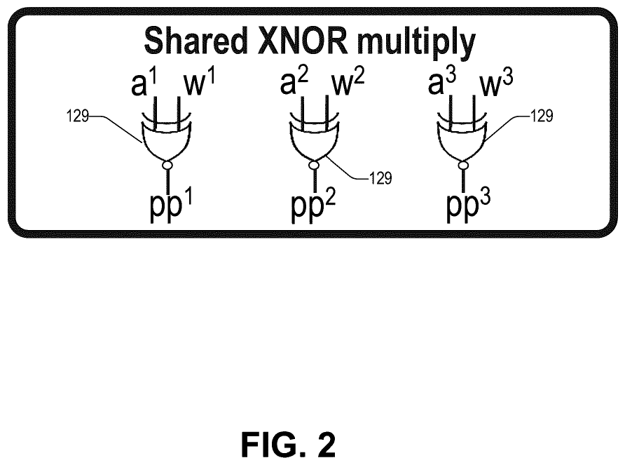

Referring now to FIG. 2, an example shared compute scheme used by the side channel secure multiply logic module 125 is shown according to an embodiment. The logic gates 129 are implemented to provide a shared XNOR gate multiply function. As will be appreciated, the shared compute scheme of FIG. 2 does not require PRNG random bits during the operation and also minimizes compute latency. Bit-serial multiplication is performed with linear XNORs rather than non-linear AND gates, so no subsequent register stage or random bit refreshing is necessary for security.

An XOR or XNOR gate is used because the sharing done in the XOR domain is already linear. The function may be split up without having any extra overhead processing requirements, for example, without requiring any random bits to maintain the distributions as the same. So, if the multiply can be made using XOR gates instead of traditional multiply techniques, significant processing power can be saved on the many multiply operations performed. Similarly for the adder tree, half adders are not secure by default in a conventional in-memory compute architecture because those use these AND gates and require random bits. The subject architecture may include one or more carry-save adder (CSA) trees which use only full adders that will be more secure by default implementations. The CSA aggregates partial products of a multiply function in each clock cycle instead of a standard ripple carry adder (RCA). This reduces latency since register stages are not necessary to maintain the shares' separation in the carry propagation path. Instead of reducing the output to 1 carry and sum per bit within the tree, the last couple layers of addition are performed concurrently with bit-serial accumulation to lower total latency. The CSA tree simplifies randomness requirements for SCA security, since it does not contain non-uniform half adders.

Similarly for the bit serial accumulator of the IMC circuit 110, natively uniform adders may be used. Bit-serial accumulation is performed by a 2 stage, 1 clock latency circuit that maintains the same CSA format. When accumulating the activation most significant bit (MSB), the previous partial sum must be reset. However, adding shared secret partial sum outputs to known reset 0s (shared as [0,0,0]) is not secure. Security may be achieved by gating adders and directly setting secret values to the sum if possible, or resetting the previous partial sum to random shares of 0 ([r1, r2, r1\hat{ }r2]) if it is not. For each column's 7 shares of 0, rather than using an always-on PRNG, accumulations of prior unrelated activations generate bits appearing random and independent may be used, and true random bits are only required when powering on the chip.

The XOR/XNOR gates, with a carry save adder, and an accumulator, interleaved with SRAM cells are used for computation. The computation block interacts with the finite state machine 133 to get noise-stabilized bits. The noise-stabilized bits are used for the secret key for the cipher for model decryption, which gets the encrypted model from off-chip. The structure may be considered “interleaved”, since, physically, the SRAM memory block may be manually laid out so that the memory block has a few SRAM cells, then a multiply circuit, then adder tree circuit(s), then accumulate circuit, then more SRAM cells, and so on.

Most NN applications require large models that do not fit within the SRAM IMC capacity. BPAs can reconstruct data when it is being transferred from off-chip DRAM, necessitating weights to be encrypted during off-chip storage and transfer. In one embodiment, the NIST-standard lightweight ASCON cipher is used for authenticated decryption, which adds minimal SCA security overhead due to its low algebraic order and can provide additional features like NN model authentication. Existing bits of the state are used to remask bits for S-box uniformity without external random bits during the decryption.

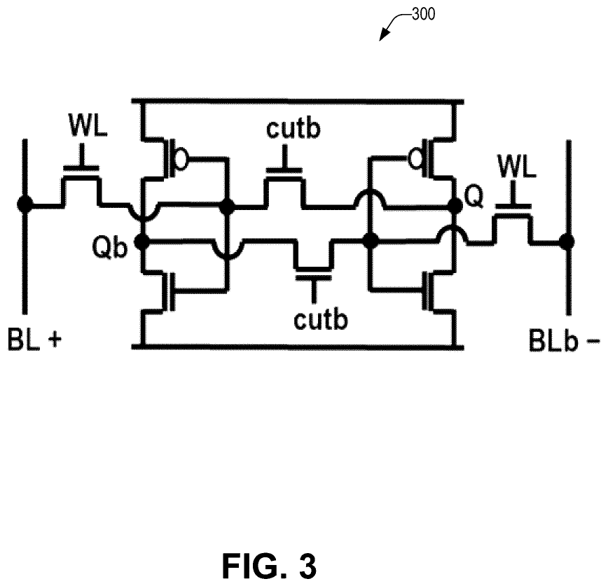

Weight decryption requires a secret key, but feeding it from an off-chip source is insecure. FIG. 3 shows an SRAM cell 300 (which may be analogous to the bit cells 127 of FIG. 1) configured as a feedback-cut PUF. As general benefits, the feedback-cut PUF does not require powering off the bank and losing pre-loaded IMC weights. PUFs can generate keys on-demand. A fixed value may be written immediately prior to evaluation to eliminate reliance on weight data. SCA-secure writes may be used to protect beyond 1st-order DPA security for repeated temporal majority voting (TMV) evaluations. For evaluation, feedback is cut and re-connected, then the SRAM settles to 0/1 based on the cross-coupled inverters' relative strengths.

FIG. 3 shows a detailed representation of the SRAM bit cell 127 in FIG. 1 which used to generate keys. The PUF cell of FIG. 1 may be implemented with the 8T SRAM bit cell 127 with feedback between the positive and negative arms that can be cut and reconnected for repeatable and random resets of the SRAM storage bit. As shown in FIG. 3, cross-coupled inverters are connected together in the SRAM bit cell 127. If they are identical, both inverters will try to settle to the same value. But for some reason, based in fabrication, if one transistor is a little bit stronger than the other transistor in an inverter, the stronger transistor is going to try to overcome the other one in terms of this cross couple of feedback and try to pull one side to a zero and the other will be a one. To set both transistors to the same value and allow it to self-determine which will dominate, the feedback may be cut and then reconnected, so then the feedback-cut circuit of the PUF cell settles to whatever its preferred state is. This configuration produces very low overhead in the accelerator 100 because SRAM that is typically in the accelerator is leveraged as a reusable source of randomness for the memory compute operation. In comparison, conventional techniques use a lot of complex readout peripherals of the exact current values or they require you to power off and power on the SRAM bank, which may be difficult if portions of the SRAM memory bank are still being used for computations at the same time as the key generation. The subject feedback-cut circuit of the PUF cell can focus on just one word line or one bit line, cut the feedback, and then retrieves a specific portion of the key just when necessary.

As will be appreciated, evaluations and reads are side channel attack secure by construction, since exactly one side of the bit cell (SRAM cell 300) gets charged or discharged regardless of data. The SRAM arms' loads must be balanced to avoid biases, so both arms drive inverters before feeding the compute operation. Remaining biases can be eliminated with methods such as Von Neumann debiasing. Side channel attacks of the shared TMV will not reveal the unshared key, but can leak statistics that reduce complexity of breaking the cipher. To address this vulnerability, TMV logic may be implemented differentially for constant power regardless of data. While SRAM PUFs are typically affected by negative-bias temperature instability aging, the near randomness of the weights stored during normal operation can partially offset this by alternating which transistor is experiencing aging. Burn-in hardening techniques can also increase initial PUF reliability in some embodiments.

### Methodology

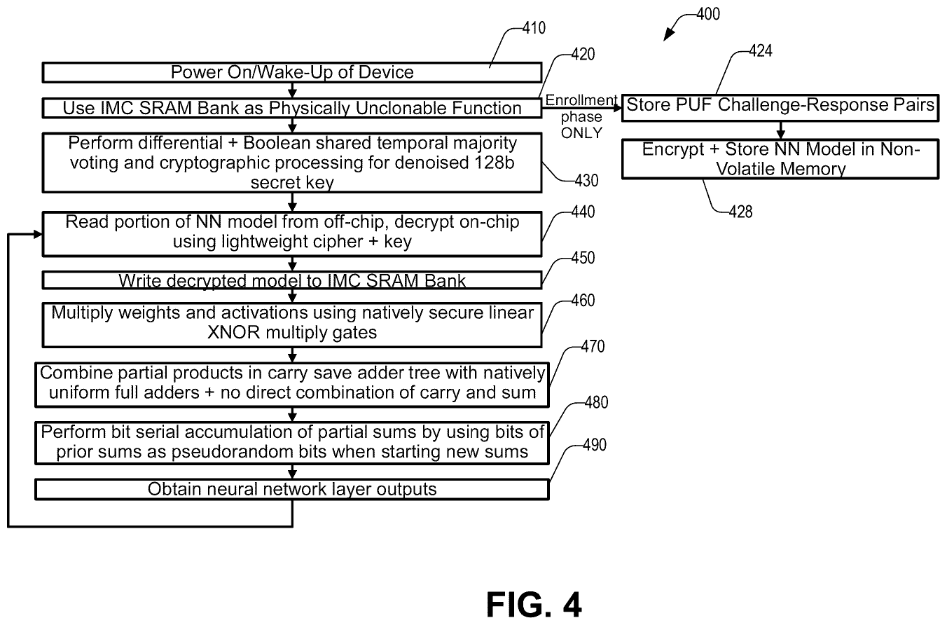

Referring now to FIG. 4, a method 400 of operating an accelerator to process neural network model data is shown according to an embodiment. In block 410, a computing device (for example, a computing chip and/or an accelerator) is powered on. The in-memory compute SRAM bank in the accelerator may be used as a physically unclonable function to generate a secret key (block 420). In the enrollment phase, out at the manufacturer, one or more tables of PUF challenge and response pairs may be generated at block 424. The responses may be used to encrypt the neural network model for the corresponding chip at block 428.

At block 430, the key is generated again locally on the chip without sending the key anywhere off chip once it is deployed. The local generation of the key may be a noiseless (e.g., denoised) version based on temporal majority voting. If needed, any cryptographic processing may be performed to make sure the entropy is high. Afterwards in a loop (which starts at block 440), parts of the model are retrieved from off the chip and are decrypted locally. In block 450, the decrypted model is written to the IMC SRAM bank. After the IMC compute operation is performed (described in detail below in association with blocks 460 through 480), neural network layer outputs are obtained in block 490 and the process may loop back to process the next part of the model retrieved from off-chip in block 440.

Block 460 through block 480 describes an example IMC compute operation. At block 460, Weights and activations may be multiplied using natively secure linear XNOR multiply gates. At block 470, partial products may be combined in a carry save adder tree(s) with natively uniform full adders. In some embodiments, no direct combination of carry and sum is used. At block 480, bit serial accumulation of partial sums is performed using bits of prior sums as pseudorandom bits then starting new sums.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An accelerator device architecture for a computing chip, comprising:
a Boolean shared in-memory circuit for side-channel attack security;
a cipher circuit coupled to the in-memory circuit for bus probing attack security; and
a physical-unclonable function (PUF) cell coupled to the in-memory circuit, wherein the PUF cell is configured to generate a security key using memory in the in-memory circuit.

2. The accelerator device architecture of claim 1, wherein the in-memory circuit memory is static random access memory (SRAM).

3. The accelerator device architecture of claim 1, further comprising a side channel secure multiply logic module including one or more XNOR gates in the in-memory circuit configured to provide a multiply function.

4. The accelerator device architecture of claim 3, wherein the side channel secure multiply logic module further comprises one or more carry-save adder trees configured to aggregate partial products of a multiply function.

5. The accelerator device architecture of claim 3, wherein the side channel secure multiply logic module further comprises a bit serial accumulator including one or more natively uniform adders generating bits based on accumulations of prior unrelated activations configured to generate bits appearing random and independent of each other for secure most significant bits computations.

6. The accelerator device architecture of claim 1, wherein the PUF cell includes a feedback-cut circuit.

7. The accelerator device architecture of claim 1, wherein the cipher circuit is located on the computing chip and configured to decrypt neural network model data.

8. A computing chip, comprising:
an input for receipt of encrypted neural network data; and
a digital in-memory compute accelerator, including:
a Boolean shared in-memory circuit for side-channel attack security;
a cipher circuit coupled to the in-memory circuit for bus probing attack security and coupled to the input for receipt of encrypted neural network model data; and
a physical-unclonable function (PUF) cell coupled to the in-memory circuit,
wherein the PUF cell is configured to generate a security key used to decipher the encrypted neural network model data using memory in the in-memory circuit.

9. The computing chip of claim 8, wherein a memory bank of the in-memory circuit memory is static random access memory (SRAM).

10. The computing chip of claim 8, further comprising a side channel secure multiply logic module including one or mor XNOR gates in the in-memory circuit configured to provide a multiply function.

11. The computing chip of claim 10, wherein the side channel secure multiply logic module further comprises one or more carry-save adder trees configured to aggregate partial products of a multiply function.

12. The computing chip of claim 10, wherein the side channel secure multiply logic module further comprises a bit serial accumulator including one or more natively uniform adders generating bits based on accumulations of prior unrelated activations configured to generate bits appearing random and independent of each other for secure most significant bits computations.

13. The computing chip of claim 8, wherein the PUF cell includes a feedback-cut circuit.

14. The computing chip of claim 8, wherein the neural network model data is located off the computing chip.

15. A method of operating an accelerator on a computing chip to process neural network model data, comprises:
generating a physically unclonable function (PUF) cell in an in-memory compute circuit of the accelerator;
generating a secret key with the physically unclonable function cell using an in-memory compute memory bank in the accelerator;
retrieving a part of a neural network model from off the computing chip;
decrypting the retrieved part of the neural network model locally on the computing chip using the secret key generated from the physically unclonable function cell;
writing the decrypted retrieved part of the neural network model to the in-memory compute memory bank;
performing an in-memory compute operation on the decrypted retrieved part of the neural network model; and
obtaining neural network output data on the computing chip from the performance of the in-memory compute operation.

16. The method of claim 15, wherein the in-memory compute memory bank is an SRAM bank.

17. The method of claim 15, further comprising, generating one or more tables of PUF challenge and response pairs and encrypting the neural network model data using the PUF challenge and response pairs.

18. The method of claim 15, further comprising generating the secret the key again locally on the chip, wherein the local generation of the secret key is denoised, based on temporal majority voting.

19. The method of claim 15, wherein the in-memory compute operation comprises multiplying weights and activations using natively secure linear XNOR multiply gates.

20. The method of claim 19, wherein the in-memory compute operation combining partial products obtained from the multiplying of weights and activations, in a carry-save adder tree with natively uniform full adders.
